(19) United States
(12) Patent Application Publication
(10) Pub. No.: US 2020/0323716 A1
(43) Pub. Date: Oct. 15, 2020

(54) Sliding Height Adjustable Bed Assist Bar

(71) Applicant: Patrick Gallagher, Grand Haven, MI (US)

(72) Inventor: Patrick Gallagher, Grand Haven, MI (US)

(21) Appl. No.: 16/381,198

(22) Filed: Apr. 11, 2019

(51) Int. Cl. A61G 7/053; A61G 7/05

(52) U.S. Cl. CPC A61G 7/053; A61G 7/0516

(57) ABSTRACT

One embodiment is a slidable middle bar (FIG. 1A) that connects to the main rod (FIG. 2) which ultimately connects to the entire bed assist bar (FIG. 5). The slidable middle bar allows for an accurate fit for all of the different bed types. Once the accurate fit is achieved, then the user can utilize the bed assist bar to help them get in and out of bed. With the accurate fit to the bed, one achieves increased stability from proper perpendicularity of the handle to the ground. Other embodiments are described and shown.

### BACKGROUND OF INVENTION

### 1. Field of the Invention

The present invention relates to an apparatus for assisting a user in getting in and out of bed, and more particularly to an apparatus and devices for providing persons with less than full mobility access to and from a bed.

The following is a tabulation of some prior are that presently appears relevant:

U.S. Patents

| Patent Number | Kind Code | Issue Date | Patentee |
|---|---|---|---|
| 2,648,850 | B1 | Aug. 18, 1953 | Robert Warren |
| 3,176,322 | B1 | Apr. 6, 1965 | Ruth Mulcahy |
| 3,310,817 | B1 | Mar. 28, 1967 | Dale Harding |
| 3,474,473 | B1 | Oct. 28, 1969 | Orrin Hannaberg |
| 5,195,200 | B1 | Mar. 23, 1993 | Thomas Leoutsakos |
| 5,231,721 | B1 | Aug. 3, 1993 | Michael Fish |
| 5,400,450 | B1 | Mar. 28, 1995 | Thomas Leoutsakos |
| 5,787,530 | B1 | Aug. 4, 1998 | Ruth Brix |

Bed assist bars were designed and adapted from hospital bed rails for home beds in order to provide people who were elderly or disabled a stable platform to assist with getting in and out of bed, as well as standing near the bed. There are many designs in commercial use today, some that go under the mattress only and some that have legs going to the ground. All designs have some type of bar or handle that extends up from the side of the bed to grab onto or hold onto as one gets in and out of the bed.

The prior art all contain height adjustability in pre-set increments. The majority of bed assist bars in present use today use 1-inch increments for height adjustability; which will only provide a mediocre fit on some beds and others will not fit at all, due to differing bed heights.

Consumers are limited to a few versions of bed assist bars for home beds through current distribution and with this height adjustment issue. None of them maybe viable. This creates a major problem for consumers, many of which are elderly or disabled, because they may spend upwards of one hundred dollars for a bed, unsure of whether or not it will fit their bed until they get it home. Due to the inconvenience of returning the item they settle for a poorly fitting bed assist bar.

A poorly fitting bed assist bar will not have perfectly perpendicular angle between the bed and the floor, causing it to be unstable and wobbly. This ultimately creates an unsafe, or at least perceived unsafe and undesired platform for assistance getting in and out of bed.

Lastly, the uneven fit can create an indent or protrusion in the bed, causing the user to have to sleep on an uneven surface.

### SUMMARY

A first embodiment includes a hollow cylinder affixed to a rod, that connects to another smooth rod. Creating a slidably height adjustable, middle portion of a bed assist bar.

### ADVANTAGES

Accordingly, several advantages of one or more aspects are as follows: the sliding height bed assist bar creates a better fit between the bed and the ground, the better fit helps to create a more stable bar, and the sliding height fits all beds within the height range, not limited to 1-inch intervals.

### DRAWINGS—FIGURES

In the drawings, closely related figures have the same number but different alphabetic suffixes,

FIG. 1a to 1b show various aspects of the hollow cylinder attached to a rod.

FIG. 2 shows a smooth cylindric rod with an enclosure at the top, or the main rod.

FIG. 3 shows a top perspective of the hollow cylinder attached to the rod.

FIG. 4 shows a bottom perspective of the hollow cylinder attached to the rod.

FIG. 5 shows the hollow cylinder attached to a rod, connected to the main rod and the middle bar extension.

FIG. 6 is the full perspective with invention attached to bed assist bar.

Drawings-Reference Numerals

| | | | |
|---|---|---|---|
| 10 | Hollow cylinder | 12 | Holes to retain middle bar |
| 14 | Opening for middle bar | 16 | Rod |
| 20 | Opening | 22 | Main rod |
| 24 | Top of main rod | 26 | Quick Release snap button for feet |
| 60 | Retaining clip | 62 | Bottom feet |
| 64 | Top of bottom feet | 66 | Under bed middle bar |
| 68 | Top Handle | | |

### DETAILED DESCRIPTION

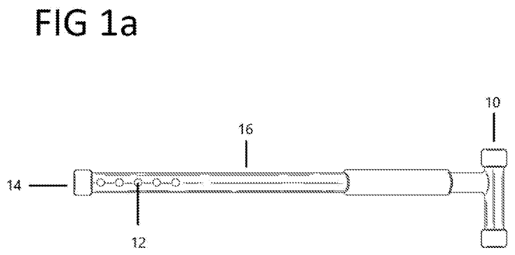

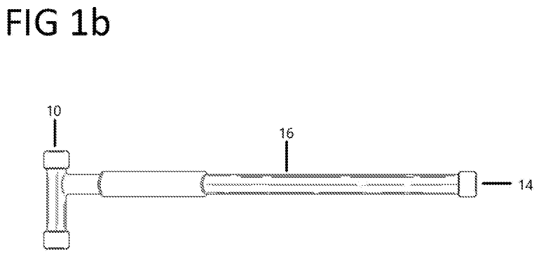

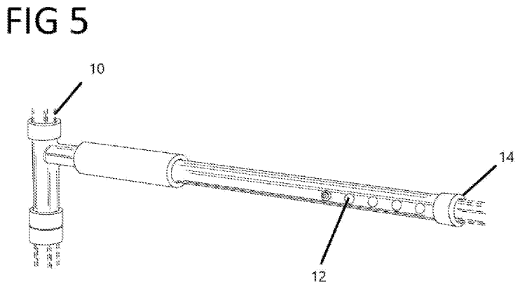

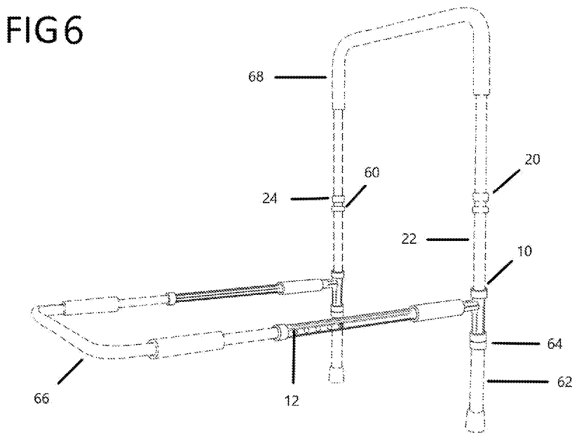

One embodiment of the bed assist bar is shown in FIG. 6 (full perspective). The bed assist bar consists of FIG. 1a (sliding height T-bar) with an open cylinder 10 attached to a rod 16. The rod 16 contains an opening 14 for the under bed middle bar 66 as well as holes 12 to secure the under bed middle bar 66. This is portrayed in FIG. 5 (middle bar attached).

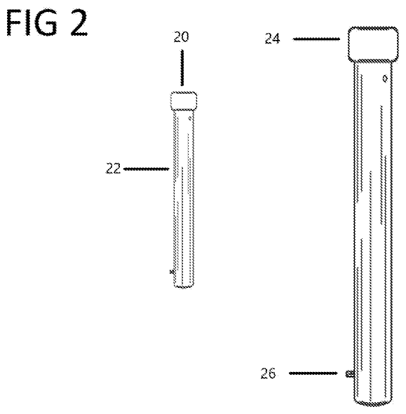

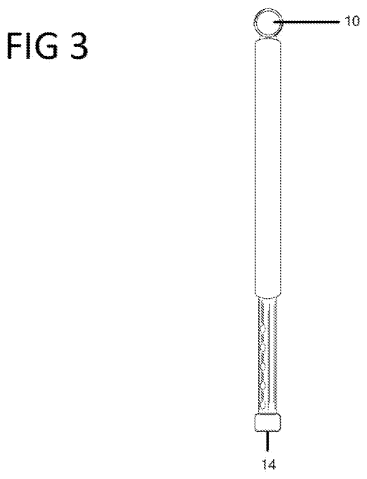

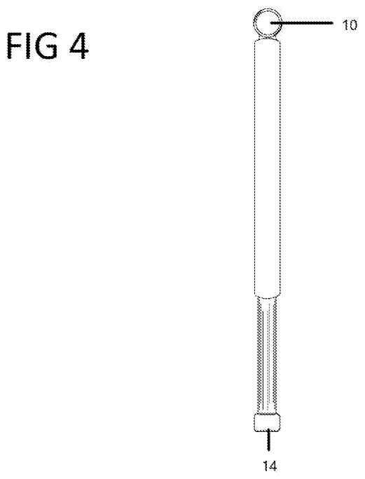

The sliding height t-bar FIG. 1a, then slides over main rod 22 shown in FIG. 2 (main rod) then FIG. 1a can freely slide to any height in between the top of main rod 24 and top of bottom feet 64.

Once the FIG. 1a (sliding height t-bar) is attached to FIG. 2 (main rod), the bottom feet 62 are attached onto main rod 22, secured with a quick release snap button 26. Once bottom feet 62 are attached top of bottom feet 64 keep the hollow cylinder 10 from sliding below the minimum height. Bottom feet 62 secure the bed assist bar to the floor. Then, the top handle 68 is placed inside opening 20 and secured with clamps 60, which also keeps FIG. 1a from sliding too high.

Finally, under bed middle bar 66 and both left and right rods 16 go in between the mattress and box spring, or bottom of the bed. Once completely assembled, the bed assist bar can slide to any desired height of the bed for attachment. When inserted in between the mattress and box spring, or bottom of the bed, the under bed middle bar 66 and rod 16 will no longer move vertically.

Operation

The way one uses the sliding height adjustable bed assist bar is similar to bed assist bars in present use. The user would place the middle portion of the bed assist bar between the box spring and mattress of the users bed.

Once the user has placed the middle bar between the mattress and box spring, the user would then secure the system to the bed, using a safety strap.

After the bed assist bar is attached to the bed, the user can grab the top handle, or top bar of the bed assist bar, while lying down and use their arm to pull themselves out of bed. The user can also use the top bar to support themselves getting into bed safely. Lastly, the user can utilize the bed assist bar to help stabilize the user as they stand next to the bed.

Advantages

From the description above, a number of advantages of some embodiments of the sliding height adjustable bed assist bar become evident:

(A) With a slidable middle bar, the bed assist bar can achieve a better perpendicular state between the bed and the ground.

(B) With a slidable middle bar, the bed assist bar can fit more beds and box spring and mattress combinations.

(C) Because a better fit is achieved, the bed assist bar is arranged at an accurate right angle, which makes the bar more stable when users are trying to get in and out of bed.

(D) This design makes it easier to take apart and reassemble the bed assist bar.

Conclusion, Ramifications, and Scope

Thus the reader will see that at least one embodiment of the bed assist bar provides a better fitting, more stable and economical device for anyone of any age in need of assistance getting in and out of bed. The sliding height adjustable bar even creates a better surface, so that users don't experience any lumps in their bed, caused by the bed assist bar.

While the above descriptions contain many details, these should not be construed as limitations on the scope, but rather as an exemplification of one embodiments thereof. Many variations are possible. For example, the sliding height adjustable bed assist bar could be made larger or smaller. The sliding height adjustable bed assist bar could be made in any material, many different shapes, and any color.

Thus the scope of the embodiments should be determined by the appended claims and their legal equivalents, rather than by the examples given

I claim:

1. A bed assist bar comprising:
A sliding height adjustable middle bar.

2. A bed assist bar apparatus as in claim 1, wherein said sliding height adjustable middle bar is adjustable by sliding with respect to said bed assist bar.

3. A bed assist bar apparatus as in claim 1, wherein said height adjustable middle bar is comprised of a hollow cylinder attached to a rod.

4. A bed assist bar apparatus as in claim 1, wherein said hollow cylinder as in claim 3 is attached to a rod and secured to a smooth cylindric rod on said bed assist bar.

5. A bed assist bar as in, claim 1, wherein said sliding height adjustable middle bar is positioned between a top and bottom limiting apparatuses.
